(19) United States
(12) Patent Application Publication
(10) Pub. No.: US 2006/0143449 A1
(43) Pub. Date: Jun. 29, 2006

(54) Security-translator

(75) Inventors: Martin Groger, Stuttgart (DE); Markus Fohrenck, Ludwigsburg (DE); Christian Scholz, Schwieberdingen (DE)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/285,282

(22) Filed: Nov. 23, 2005

(30) Foreign Application Priority Data
Dec. 23, 2004 (EP) 04293124.6

(51) Int. Cl. H04L 9/00

(52) U.S. Cl. 713/166

(57) ABSTRACT

A security translator (STL) that serves for connecting a data network (N2) pertaining to a lower security level to a data network (N1) pertaining to a higher security level examines its own integrity at definite intervals in order to ascertain malfunctions and, where appropriate, to trigger a transition to the secure failure state. The secure failure state consists in the connection from the data network with a lower security level to the data network with a higher security level being interrupted. This is obtained by means of a watchdog circuit (WD1, WD2) which keeps the connection (CTN) between the data network (N2) with a lower security level and the data network (N1) with a higher security level closed as long as it receives regular signs of life and which automatically interrupts the connection if it receives no sign of life over a predetermined period.

The invention is based on a priority application EP 04293124.6 which is hereby incorporated by reference.

### BACKGROUND OF THE INVENTION

The present invention relates to an apparatus and to a process for connecting a data network pertaining to a lower security level to a data network pertaining to a higher security level, in particular for applications that are highly relevant to security, such as railway technology.

In the case of security-relevant applications, data networks have to be secured against penetration from outside, such as hacker attacks, for example. But, on the other hand, there is often precisely a need to connect data networks with a lower security level to data networks with a higher security level. This is done ordinarily by interposition of a so-called firewall—i.e. a device that serves to prohibit operations from outside that are not permitted.

A particularly security-relevant application consists in railway technology. Network areas pertaining to a particular security category are designated therein as integrity areas (IB). Although the term ‘integrity area’ originates from the field of application of control and operating systems for electronic railway control centers, it will nevertheless be used in a more general sense in this document.

Within the scope of a control and operating system for electronic railway control centers there are three layers of integrity: The IB1 is the operational—that is to say, security-relevant—area, in which a railway control center is operated by traffic controllers (from a so-called subordinate control centre or central control centre). The IB2 is the management-specific, security-irrelevant area, in which schedulers have an overview of the entire area covered by the operational control centre but do not operate the railway control center, but rather, if need be, issue (electronic) instructions to the traffic controller or to the train routing system. Finally, the IB3 is a network area pertaining to the railway operator that has a lower security level than the IB2 and that serves for internal communications of the railway operator.

The architecture of the control and operating system provides for the interworking of systems in the IB1 with systems in the IB3. At the transition-point a device is required that effectively prevents the penetration of information that could harm the signalling systems of the IB1 in terms of their functioning and integrity. This device will be designated in the following as a security translator. Although the IB3 is not a completely uncontrolled area, it has to be assumed that it offers no guarantee against unauthorised access or against corruption of telegrams. The security translator must therefore prevent any inadmissible access from IB3 to IB1.

In this regard it is important that no breach of security arises in the event of failure or malfunctions of the security translator. Therefore in the event of technical malfunctions it has to pass into a secure failure state in which no accesses from IB3 to IB1 are any longer possible.

### SUMMARY OF THE INVENTION

It is therefore an object of the invention to specify an apparatus and a process for connecting a data network pertaining to a lower security level to a data network pertaining to a higher security level, said apparatus reliably suppressing inadmissible accesses from the data network with a lower security level to the data network with a higher security level and passing into a secure failure state in the event of a fault.

These and other objects are achieved by means of an apparatus for connecting a data network pertaining to a lower security level to a data network pertaining to a higher security level.

The apparatus contains
a telegram filter for filtering telegrams out of the data network with a lower security level in accordance with predetermined filter rules,
a first checking component which is designed to generate checking telegrams and to send them via the telegram filter to a second checking component and
a watchdog circuit activated by the second checking component, which is designed to keep the connection between the data network with a lower security level and the data network with a higher security level closed as long as it receives regular signs of life from the second checking component and which is designed to interrupt the connection automatically if it receives no sign of life over a predetermined period.

The second checking component is further designed to generate a sign of life for the watchdog circuit after receipt of a checking telegram that is permitted in accordance with the filter rules and to suppress a generation of signs of life for the watchdog circuit for at least the predetermined period after receipt of a checking telegram that is not permitted in accordance with the filter rules.

According to another aspect of the invention/a method is provided for checking the integrity of an apparatus that serves for connecting a data network pertaining to a lower security level to a data network pertaining to a higher security level and that contains a telegram filter for the purpose of filtering telegrams out of the data network with a lower security level in accordance with predetermined filter rules and contains a watchdog circuit which is designed to keep the connection between the data network with a lower security level and the data network with a higher security level closed as long as it receives regular signs of life and which is designed to interrupt the connection automatically if it receives no sign of life over a predetermined period. The method contains the following steps:
checking telegrams are generated and are sent to a checking component via the telegram filter,
after receipt of a checking telegram that is permitted in accordance with the filter rules the checking component generates a sign of life for a watchdog circuit and
after receipt of a checking telegram that is not permitted in accordance with the filter rules the checking component suppresses a generation of signs of life for the watchdog circuit for at least a predetermined period.

The security translator examines its own integrity at certain intervals in order to establish malfunctions and, where appropriate, to trigger a transition to the secure failure state. According to the invention, the secure failure state consists in the connection from the data network with a lower security level to the data network with a higher security level being interrupted. This is obtained by means of a watchdog circuit, which keeps the connection between the data network with a lower security level and the data network with a higher security level closed as long as it receives regular signs of life and which automatically interrupts the connection if it receives no sign of life over a predetermined period.

The security translator possesses a telegram filter for the purpose of filtering telegrams out of the data network with a lower security level in accordance with predetermined filter rules. In addition, the security translator possesses a first checking component and a second checking component. The first checking component generates checking telegrams and sends them via the telegram filter to the second checking component. After receipt of a checking telegram that is permitted in accordance with the filter rules the second checking component generates a sign of life for the watchdog circuit, and after receipt of a checking telegram that is not permitted in accordance with the filter rules it suppresses the generation of a sign of life for the watchdog circuit for at least the predetermined period.

Hence positive and negative properties of the filter device of the security translator can be demonstrated within a defined failure-revelation time, which in turn enables the demonstration of a low residual-error probability of the system, so that said system can be licensed for railway-technology applications.

### BRIEF DESCRIPTION OF THE DRAWINGS

An exemplary embodiment of the invention will be elucidated in detail in the following on the basis of the drawings. Shown are:

FIG. 1 a security translator which establishes a connection between two data networks with different security levels,

FIG. 2 a detailed view of the security translator from FIG. 1,

FIG. 3 the physical interconnection of the network components of the security translator from FIG. 1,

FIG. 4 a flow chart for checking the filter function of the security translator,

FIG. 5 a flow chart in the event of failure of the filter function of the security translator,

FIG. 6 a flow chart for checking the watchdog circuits,

FIG. 7 a flow chart in the event of failure of the watchdog circuit [sic],

FIG. 8 a flow chart in respect of checking of sequence-number error and checksum error,

FIG. 9 a flow chart in the event of failure of the checking in respect of sequence-number error and checksum error and

FIG. 10 a checking plan.

### DETAILED DESCRIPTION OF THE INVENTION

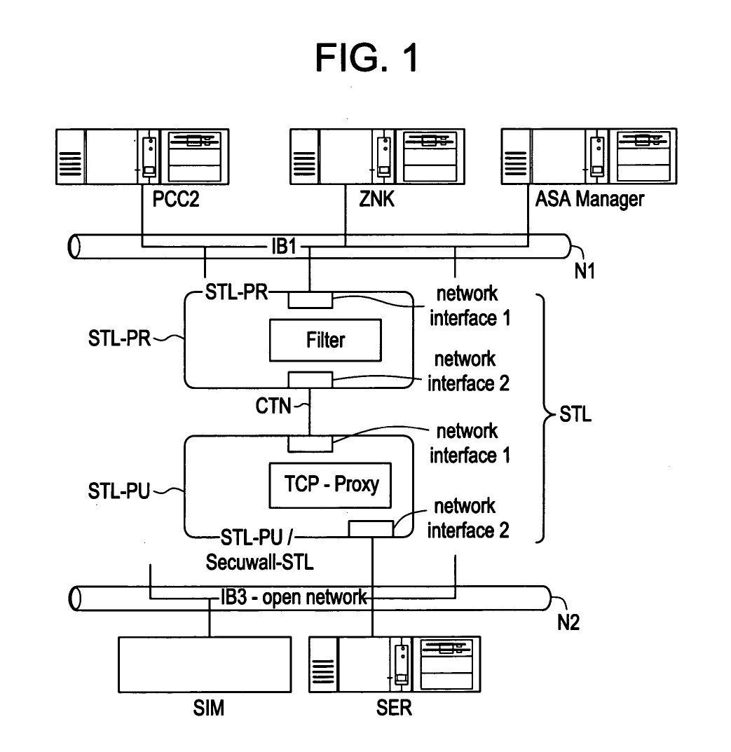

A first data network N1 and a second data network N2 are represented in FIG. 1. The first data network corresponds to the integrity area IB1, and the second data network corresponds to the integrity area IB3. The IB1 is a security-relevant area, and the IB3 is regarded as an area pertaining to a lower security level.

Between the two data networks there is arranged a security translator STL which establishes a secure connection between the two data networks. The security translator STL consists of a conventional firewall STL-PU with TCP proxy, which is connected to the data network N2, and of a filter device STL-PR, which is connected to the data network N1. The firewall STL-PU and the filter device STL-PR are connected to one another by means of the TCP/IP protocol via a separate Ethernet network CTN.

Linked to the data network N1 in exemplary manner are a train-number core (Zugnummernkern) ZNK, an Application Supervision Agent Manager ASA and a Protocol Conversion Computer PCC2. In this case, it is a question of components, known as such, that are found in a railway control center. Linked to the data network N2 in exemplary manner are a serial subsystem SER and a simulator SIM, which are likewise known as such and are found in the network area of railway operators.

The security translator STL is a device that serves to prevent the penetration of information that could harm signalling systems of the IB1 in terms of their functioning and integrity. The STL prevents forbidden access from IB3 to IB1. To this end, it only supports communication via SBS-like protocols that are transported on the basis of TCP/IP. The structure of a telegram will be elucidated more precisely further below. There is no IP transparency through the STL—i.e. no PING, for example, is possible between the data networks N1 and N2 via the STL.

The protocol is capable of tolerating a daily connection interruption of up to 10 seconds. An application can achieve this by temporary storage of the unsuccessfully dispatched telegrams and by subsequent repetition of the dispatch. A further possibility consists in generating a new upgrade request after sequence-number errors have been established.

The firewall STL-PU is responsible for repelling attacks via the communication layers 1-4 (according to the ISO/OSI reference model, see ISO/OSI—Basic Reference Model ISO/IEC 10731/1994) from the data network N2. A firewall component with TCP proxy is provided for this.

In the exemplary embodiment the tasks of the firewall STL-PU are undertaken by the commercially available product Secuwall-STL marketed by Secunet. The Secuwall-STL is based on a specially minimised and hardened Linux operating system; it is provided with powerful firewall functionalities, as well as intrusion, detection & response functions. An integrated TCP proxy provides for security against attacks up to and including communication layer 4.

The firewall STL-PU serves as a proxy between IB3 applications in the data network N2 and the filter device STL-PR—i.e. an IB3 application sets up a TCP/IP connection to the firewall STL-PU, and the firewall STL-PU maintains an associated TCP/IP connection to the filter device STL-PR. In the course of setting up the connection, the firewall STL-PU acts as a server, a connection being accepted only at previously approved TCP ports. The firewall STL-PU logs repelled attack attempts via the SysLog protocol to the filter device STL-PR. In addition, the firewall STL-PU reports its status regularly via SysLog.

Further demands made of the firewall STL-PU are the following: the firewall STL-PU must be able to assume a secure failure state; in the secure failure state any non-administrative use of the firewall STL-PU must be suppressed; the restarting of the firewall STL-PU and the restart after the secure failure state has been assumed may be effected only by manual intervention.

The Internet protocol is exclusively permitted by way of network protocol. The IB3 applications communicate with the firewall STL-PU exclusively via TCP/IP via permanently allocated TCP ports. The firewall STL-PU is “pingable”. A ping through the firewall STL-PU to nodes in the data network N1 is not possible. The Syslog protocol is permitted for the dispatching of status information into IB1. All other network services—such as, for example, FTP, http, Telnet, SNMP—are forbidden.

For each incoming TCP connection from the data network N2 there is a connection to the filter device STL-PR. Via two separate TCP connections, checking telegrams that serve for integrity checking (see further below) are sent from the filter device STL-PR to the firewall STL-PU. The checking telegrams have to be sent back again from the proxy to the filter device STL-PR via two appropriate connections. Telegrams that come from the data network N2, as well as checking telegrams pertaining to the filter device STL-PR, are scrambled by the proxy. Telegrams from the data network N1 are not scrambled by the proxy. The user data, inclusive of checking telegrams, are received by the firewall STL-PU and are dispatched again via the assigned connection. The data received over checking-telegram connections are evaluated as signs of life. If no data are received within a configurable time, the firewall STL-PU assumes the secure failure state.

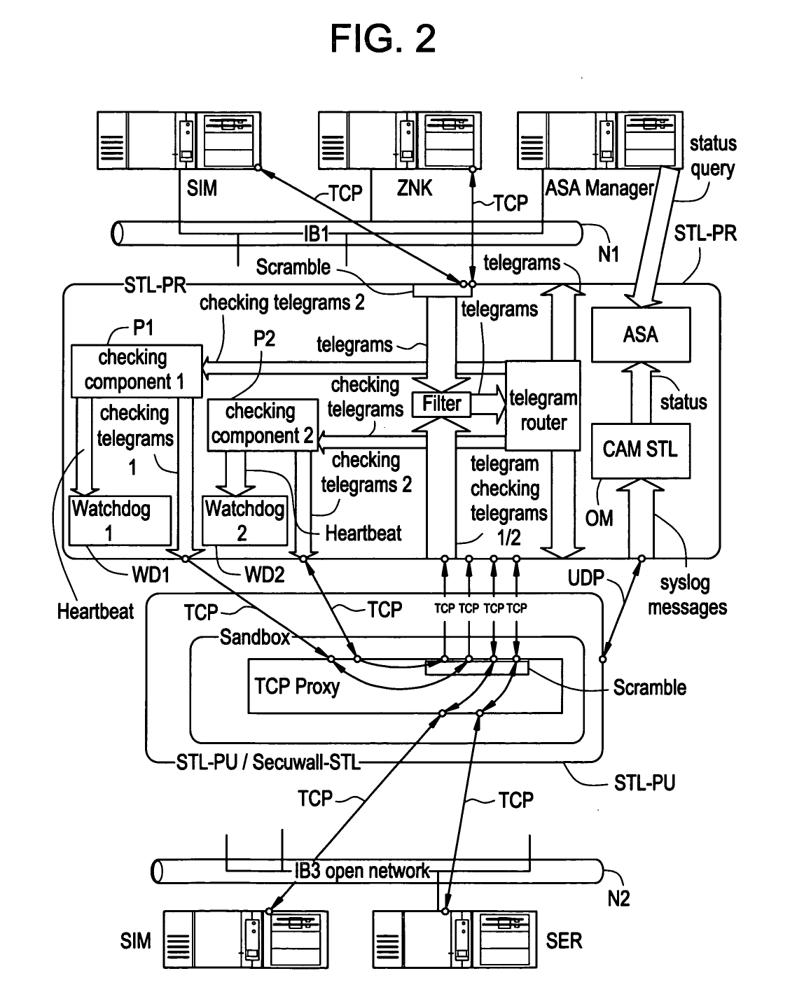

The structure of the filter device STL-PR is represented in more detail in FIG. 2.

Said filter device has the task of filtering telegrams that are sent from the data network N2 to the data network N1 at the application level. The filter device STL-PR has to report the status of the overall STL system to the system management of the IB1; it has to examine its components permanently for functional capability. Faulty or failed components result in the secure failure state.

The filter device STL-PR is connected to the firewall STL-PU via a separate Ethernet network (TCP/IP). Via the first network card there exist n (=number of communication relations between data network N2 and data network N1) TCP connections to the STL-PU. Data are transmitted between N2 and N1 over these connections.

There additionally exist four (2 sending, 2 receiving) separate TCP connections, via which only checking telegrams are transmitted. These checking telegrams are generated by the filter device STL-PR and are sent back to the STL-PR via the firewall STL-PU. The checking telegrams serve for integrity checking.

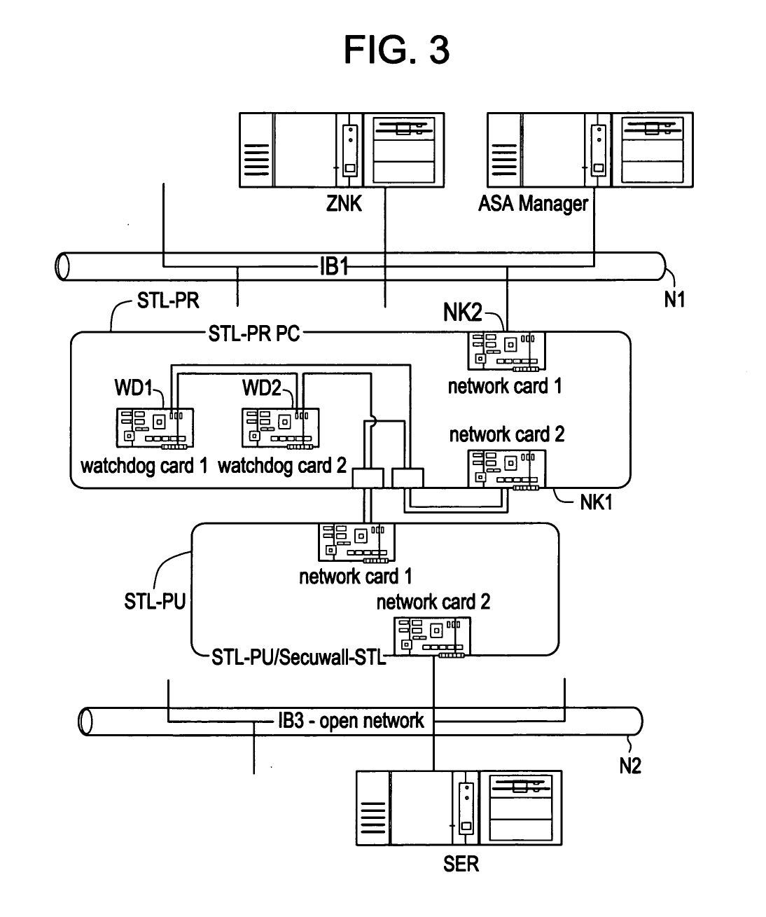

The filter device STL-PR is realised using a commercial Windows PC with two network cards and two watchdog cards WD1 and WD2. Various program modules run on the PC, namely a telegram filter TF, a telegram router TR, a first checking component P1, a second checking component P2, an OAM module OM and an Application Supervision Agent ASA. Whereas the logical structure of the filter device STL-PR is represented in FIG. 2, FIG. 3 shows the physical structure thereof.

The watchdog circuits WD1, WD2 are separate plug-in cards with their own microcontroller, which is incorporated within the filter device STL-PR. The watchdog cards operate autonomously from the rest of the PC and are responsive via the PCI interface.

The watchdog circuit WD1, WD2 has the task of establishing the secure failure state. For this purpose, the receive line of the network connection between STL-PU and STL-PR is wired to a relay on the watchdog card (see FIG. 3). The watchdog circuit WD1, WD2 has an interface to its associated checking component P1, P2, via which it receives signs of life. In the watchdog circuit a fixed time interval is configured, within which signs of life have to be received by the checking component (watchdog timeout). If no signs of life are received any longer, the network connection CTN between STL-PU and STL-PR is physically interrupted by the drop-out of the relay. The watchdog circuit is designed to be redundant. Each watchdog circuit WD1, WD2 is supplied with signs of life by an associated checking component P1, P2. A watchdog check takes place within the predetermined failure-revelation time of the watchdog card.

The individual program modules will be elucidated in more detail in the following. The lower communication layers ensure that only completely assembled application telegrams are handed over to the telegram filter TF. This means that the length field of the telegram always corresponds to the actual length of the telegram.

All the data coming in at the STL-PR from N2 and N1, and the checking telegrams, pass through the telegram filter TF. Only authorised and checked telegrams pass through the telegram filter TF. Unauthorised and invalid telegrams are rejected and logged. If a telegram is let through by the telegram filter TF, it is then routed onward to the telegram router TR.

In the exemplary embodiment the telegrams have the following fixed structure. In this regard the fields listed in Table 1 are defined for use in the control and operating system of the railway control center.

TABLE 1
Telegram Structure

| | | | | | | | | |
|---|---|---|---|---|---|---|---|---|
| Byte | | | | | | | | |
| No. | Bit 7 | Bit 6 | Bit 5 | Bit 4 | Bit 3 | Bit 2 | Bit 1 | Bit 0 |

| | |
|---|---|
| 0 | User-data length (bytes from and including user-data |
| | length up to and including protection appendix) |
| 2 | Addressee (binary-coded, bytes 1 to 3) |
| 5 | Originator (binary-coded, bytes 1 to 3) |
| 8 | Arbitrary data |
| L − 8 | Protection appendix¹⁾ (optional, mandatory with MD4 |
| | appendix check switched on) |

¹⁾L corresponds to the user-data length contained in the telegram

The structure of the telegram may read otherwise for other specific applications of the security translator STL. The structure of the telegram is not mandatory for the telegram filter TF, because the latter can, in principle, filter in respect of arbitrary patterns at arbitrary places in the telegram. But the modules of the lower communication layers that are used for operation in the control and operating system of the railway control center require the precise specification of the length field in order to reassemble the telegram from the TCP data stream. The telegram router TR requires the precise specification of the routing information (recipient and originator). If the structure of the telegram is altered for other uses, these modules have to be adapted accordingly.

At the input of the filter the telegrams are present in a scrambled state—i.e. all the bits of the received data are combined with a predetermined bit pattern by means of an XOR. Telegrams received by the filter device STL-PR were scrambled by the firewall STL-PU. Telegrams received from the data network N2 were scrambled downstream of the N1-side input of the STL-PR. At the filter input the telegrams are restored to the original state with the aid of the XOR. The scrambling at the N1-side input is only necessary in order that the telegram filter TF functions equally in both directions; it has no security function.

The telegram filter TF uses several filter rules. Each filter rule in turn includes a number of conditions. In the case where all the conditions are true, the filter rule is regarded as having been satisfied, and the telegram may pass. Upon start-up of the security translator STL, the filter rules are read out from a filter-rule file. In principle, filtering can be effected in respect of arbitrary patterns on the basis of offset and length. Hence filtering is also possible, for example, in respect of telegram type (info type), technology-type originator address, technology-type recipient address.

There are three different types of filter rules: positive rules, negative rules and checking rule. The sequence of the filter rules, according to which a telegram is checked, is permanently predetermined:

1. List of the negative rules

2. List of the positive rules

3. Checking rule

Positive rules should be mutually exclusive. In the case where a negative filter rule applies, the telegram is rejected and logged. If a positive rule for a telegram applies, the telegram is let through and routed onward. The checking rule applies to the special checking telegrams that are necessary for monitoring the integrity of the security translator STL. If none of the filter rules applies to a telegram, said telegram is logged and rejected.

A filter rule consists of the elements reproduced in Table 2.

TABLE 2
Structure of Filter Rules

| Field name | Syntax | Significance | Description |
|---|---|---|---|
| Name | String | Mandatory | Establishes the name of a filter |
| | | | rule. Checking rules are identified |
| | | | via the name “checking rule”. |
| | | | Other names are conceived for the |
| | | | purpose of assignment in the |
| | | | logging. |
| Throughput | Integer | Mandatory | Establishes the maximum number |
| | | | of telegrams per second that are |
| | | | permitted to pass through this filter |
| | | | channel. If the throughput is set to |
| | | | 0, this is a negative rule. No |
| | | | telegram with this pattern may pass |
| | | | through the filter. |
| Startposition 1 | Integer | Mandatory | Establishes the starting position of |
| | | | the telegram segment to be |
| | | | checked. |
| Pattern 1 | Hexadecimal byte sequence | Mandatory | Defines the pattern against which |
| | | | the telegram segment is checked. |
| Bitmask 1 | Hexadecimal byte sequence | Optional | It is possible to define which bits |
| | | | are drawn upon in the course of |
| | | | the comparison and which are not. |
| | | | If not present, all the bits are |
| | | | checked. |
| . . . | | | Position and pattern may repeat |
| Startposition n | | Optional | arbitrarily. A pattern must be |
| Pattern n | | Optional | allocated to each position and |
| Bitmask n | | Optional | length. |

The structure of the filter file is defined by the following XML schema:

<?xml version=“1.0” encoding=“UTF-8”?>
<xsd:schema xmlns:xsd=“http://www.w3.org/2001/XMLSchema”
xmlns=“http://www.w3.org/2001/XMLSchema”>
<xsd:element name=“Filter Rules”>

<xsd:complexType>

<xsd:sequence>

<xsd:element name=“Filter Rule” maxOccurs=“unbounded”>

<xsd:complexType>

<xsd:sequence>

<xsd:element name=“Name” type=“xsd:string”/>
<xsd:element name=“Throughput” type=“xsd:integer”/>
<xsd:element name=“PatternEntry” maxOccurs=“unbounded”>

<xsd:complexType>

<xsd:sequence>

<xsd:element name=“Startposition”

type=“xsd:integer”/>

<xsd:element name=“ Pattern” type=“xsd:string”/>
<xsd:element name=“Bitmask” type=“xsd:string”

minOccurs=“0”/>

</xsd:sequence>

</xsd:complexType>

</xsd:element>

</xsd:sequence>
</xsd:complexType>

</xsd:element>

</xsd:sequence>

</xsd:complexType>

</xsd:element>
</xsd:schema>

Example of a filter-rule file in the XML format:

<?xml version=“1.0” encoding=“iso-8859-1”?>
<Filter Rules>

<Filter Rule>

<Name>KF Condition</Name>
<Throughput>0</Throughput>
<PatternEntry>

<Startposition>1</Startposition>
<Pattern>062050</Pattern>

</PatternEntry>
<PatternEntry>

<Startposition>3</Startposition>
<Pattern>062052</Pattern>

</PatternEntry>

</Filter Rule>
<Filter Rule>

<name>ZNK - SER</Name>
<Throughput>50</Throughput>
<PatternEntry>

<Startposition>1</Startposition>
<Pattern>072554</Pattern>
<Bitmask>f0ff10</Bitmask>

</PatternEntry>
<PatternEntry>

<Startposition>8</Startposition>
<Pattern>06</Pattern>
<Bitmask>0a</Bitmask>

</PatternEntry>

</Filter Rule>
<Filter Rule>

<name>Checking Rule</Name>
<Throughput>4</Throughput>
<PatternEntry>

<Startposition>1</Startposition>
<Pattern>ffffff</Pattern>
<Bitmask>f0ffff</Bitmask>

</PatternEntry>

</Filter Rule>

</Filter Rules>

Art MD4 appendix check of the SBS protocol, which is capable of being activated via a configuration file, is also optionally carried out by the telegram filter. When the function is switched on, the security translator STL creates the MD4 hash code at the input of the telegram filter TF concerning each unchecked telegram and compares this with the transmitted MD4 appendix of the telegram. In this process only the low-order 64 bits of the MD4 hash code are compared with one another in each instance, since in a SBS telegram only half of the 128-bit MD4 hash code is transmitted. Non-conformal telegrams are logged and rejected.

In addition, the telegram filter TF performs the function of a throughput restriction. In order to prevent an inundation of the IB1 applications with permitted telegrams, the throughput in the STL-PR is restricted by the telegram filter TF. Positive filter rules and checking rules are regarded as a logical filter channel, through which telegrams are able to pass the filter. For each positive rule a threshold value (number of telegrams per unit of time) is capable of being set via a configuration file. Telegrams that exceed the threshold value are logged and rejected.

The telegram router TR realises routing functionality on the basis of SBS addresses. A projected routing table is located in the filter device STL-PR. The SBS router extracts the originator and the receiving SBS address from each telegram and routes telegrams on the basis of the project planning. This means that it routes the telegrams onward via the connection that has been ascertained. Also contained in the routing table are entries for the checking telegrams that have the corresponding checking component P1, P2 as their objective.

The checking components P1, P2 have the task of checking the functional capability of the telegram filter TF, of the watchdog circuits WD1, WD2, and of the checking component P1, P2 itself. A check is constantly made as to whether the telegram filter TF knows and is applying the filter rules. To this end, special checking telegrams are sent back periodically to the firewall STL-PU and from there to the filtering device STL-PR.

The checking components generate and send checking telegrams in accordance with a definite plan. In the following, said plan will be designated as the checking plan. Both checking components execute the same checking plan cyclically but in temporally offset manner. The temporal offset is obtained by the checking components P1, P2 being started in time-shifted manner and beginning the checking plan with varying start index. In the course of start-up of the STL-PR, firstly checking component P1 is started and begins the execution of the checking plan at Index1. Checking component P2 is then started 15 s later and begins at Index11. Checking component P1 consequently begins to examine watchdog circuit WD1 after a few minutes; checking component P2 examines watchdog circuit WD2 only after 24 hrs. Consequently, one of the two watchdog circuits WD1, WD2 is examined alternately every 24 h.

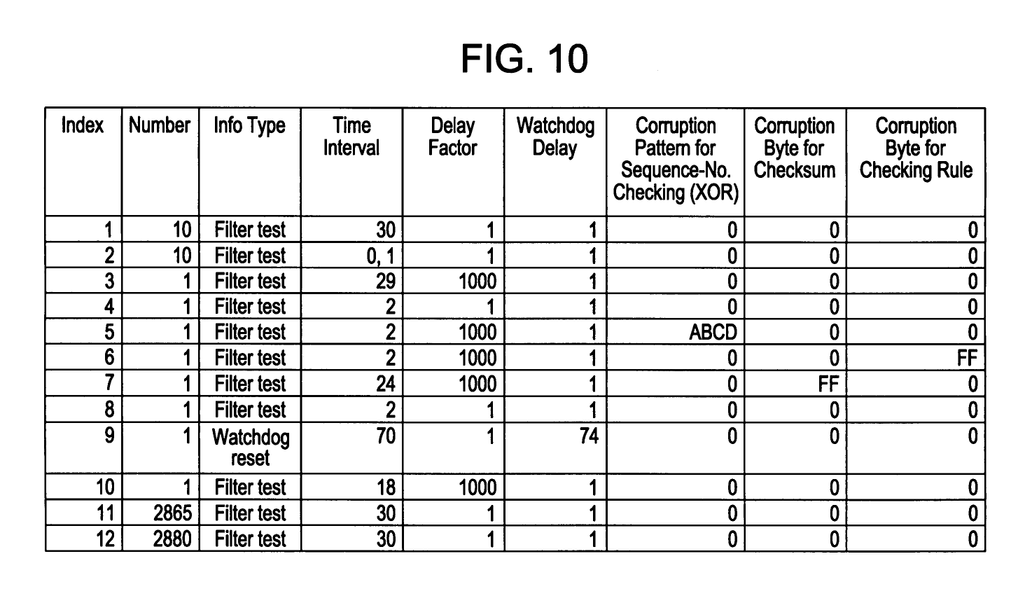

The checking plan is illustrated in FIG. 10 as Table 3. Said checking plan contains segments for filter test, throughput-restriction checking, sequence-number check, checksum check and watchdog checking. The time interval between two checking telegrams here is less than the watchdog timeout. The checking component itself has no knowledge of the function of the respective segment. The fields info type, delay factor and watchdog delay are taken from the checking plan and are inserted into the checking telegram to be sent. The checking component rounds off its own sequence number with a corruption pattern according to the checking plan and enters said sequence number into the checking telegram to be sent. In fact, the sequence number is really corrupted only once within the checking plan (sending of a telegram with incorrect sequence number). The corruption byte is entered into the checking telegram in accordance with the checking plan. For checking telegrams, an MD4 appendix is also created.

Telegrams that have to be rejected by the telegram filter are designated as poisoning telegrams, since in the case where they are erroneously not rejected they result in interruption of the connection by one of the watchdogs.

A poisoning telegram is a special checking telegram. If it is received by a checking component P1, P2, the secure failure state is assumed. For this, a poisoning telegram contains a very high delay factor. If a checking component P1, P2 receives such a telegram, the next telegram to be sent in accordance with the checking plan is delayed so much that no signs of life are sent within the watchdog timeout. Consequently the associated watchdog circuit interrupts the network permanently. This state cannot be changed by further checking telegrams; the receipt of a poisoning telegram is consequently irreversible.

Furthermore, a watchdog-reset telegram is also defined. If a checking component receives a checking telegram with this special info type, it initialises the watchdog card. The relay of the watchdog card has become operative in the initial state—i.e. the connection between STL-PR and STL-PU is not interrupted.

In exemplary manner (watchdog timeout=67 s) the checking plan is to be read as follows:

1. Send a checking telegram 10 times every 30 s

2. Wait 30 s

3. Send a checking telegram 10 times every 100 ms

4. Wait 10 ms

5. Send 1 poisoning telegram

6. Wait 29 s

7. Send 1 checking telegram

8. Wait 2 s

9. Send 1 poisoning telegram with incorrect sequence number

10. Wait 2 s

11. Send 1 poisoning telegram with corruption byte for checking rule=0xFF

12. Wait 2 s

13. Send 1 poisoning telegram with corruption byte for checksum=0xFF

14. Wait 24 s

15. Send 1 checking telegram

16. Wait 2 s

17. Send 1 watchdog-reset telegram

18. Wait 70 s

19. Send 1 poisoning telegram

20. Wait 18 s

21. Send a checking telegram 2865 times every 30 s

22. Wait 30 s

23. Send a checking telegram 2880 times every 30 s (corresponds to 24 hrs.)

24. Begin at 1.

The checking telegrams have the following structure:
Length: telegram length
Originator address: STL-specific SBS address of the component that sends the telegram.
Recipient address: STL-specific SBS address of the component that receives the telegram.
Sequence number: consecutive number
Info type: STL-specific checking-telegram info type (filter test, watchdog reset)
Delay factor: delay factor
Watchdog delay: watchdog delay
Checksum: checksum concerning the memory map of the static system data
Corruption byte for checksum:
   for purposeful corruption of the checksum
Corruption byte for checking rule:
   for purposeful corruption of the checking telegram
MD4 appendix: checksum concerning the entire telegram

The sequence numbers are needed for the purpose of creating the checksum; by virtue of these numbers, each checking telegram, and consequently also the checksum of each checking telegram, is different. All checking telegrams contain a consecutive sequence number. In the course of sending a checking telegram, each checking component inserts here the number of its previously sent telegrams. Incoming checking telegrams with a sequence number smaller than that previously received are rejected.

The checking component contains a time-interval factor in its data. In the course of receiving a checking telegram, the contained delay factor is multiplied by the time-interval factor, and the result is stored as the new time-interval factor. The temporal spacing between the sending of two checking telegrams is computed from the product of the time-interval factor and the time interval (see ‘time interval’ column in the checking plan). The checking component waits for this time before it sends a message (sign of life or reset) to the watchdog.

The OAM module writes events to files, this also being generally designated as “logging”. The following events are logged:
unauthorised telegrams,
telegrams that exceed the threshold value,
the secure failure state,
events reported by the STL-PU via SysLog (it has a UDP connection to the STL-PU, via which SysLog messages are received),
the logger can be set in such a way via a configuration file that it also logs the entire data traffic via the STL—i.e. it records all telegrams.

The OAM maintains an interface to the ASA. In principle, all the aforementioned events are reported to the ASA. In order to avoid a system overload, e.g. by virtue of permanent exceeding of the throughput, it is possible to configure how many events per unit of time are reported maximally. The OAM reports the status of the STL to the ASA cyclically.

The ASA has the task of making the events reported by the OAM module available to the IB1 system management in the data network N1. Moreover, the ASA monitors whether the OAM module is reporting the status of the STL cyclically. If this is not the case, an error message is relayed to the system management of the IB1.

The manner in which the integrity checking of the individual functions of the filter device STL-PR takes place will be described in the following.

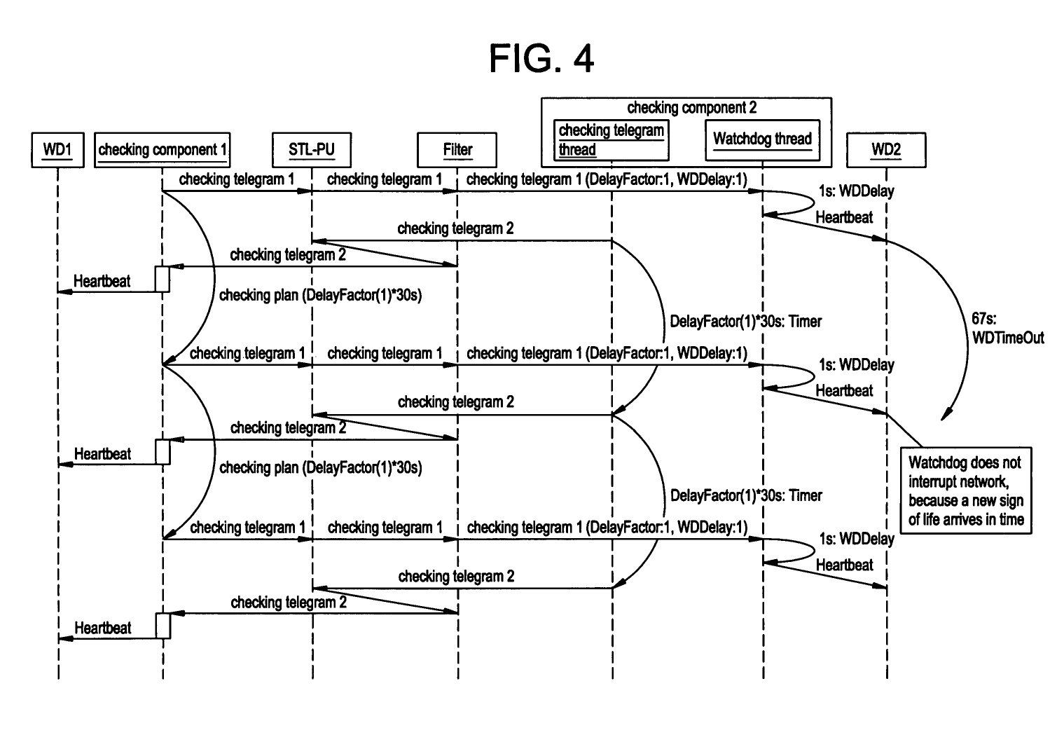

The functioning of the telegram filter TF has to be constantly monitored in ongoing operation. This is done by means of special filter-rule checking telegrams. The checking telegram passes only through the checking-telegram filter channel—i.e. it previously runs through all the negative and positive filter rules of the filter-rules system. The last filter rule is a positive rule for checking telegrams. Consequently, checking telegrams are assessed as being authorised and are forwarded to the checking component P1, P2 via the telegram router TR. If the checking component P1, P2 has received this checking telegram, it sends a sign of life to its watchdog circuit WD1, WD2. It is consequently guaranteed that the telegram filter TF is functioning—i.e. the filter rules are being applied. Lack of receipt of checking telegrams in the checking components P1, P2 leads to the suspension of the signs of life transmitted to the watchdog circuits WD1, WD2. The scenario of the filter checking is represented in a flow chart in FIG. 4.

On the basis of their checking plans the checking components P1, P2 send each other checking telegrams. These telegrams serve for filter checking and as a sign-of-life trigger for the watchdog circuits WD1, WD2. The checking plan is influenced by the delay factor contained in arriving telegrams. In the normal case the delay factor=1, i.e. the checking plan remains unaffected. The checking component sends a sign of life to its watchdog circuit after expiration of the watchdog delay (which has been read out from the received checking telegram). By virtue of this process, it is ensured that both watchdog circuits are supplied with signs of life and the network connection CTN remains in existence.

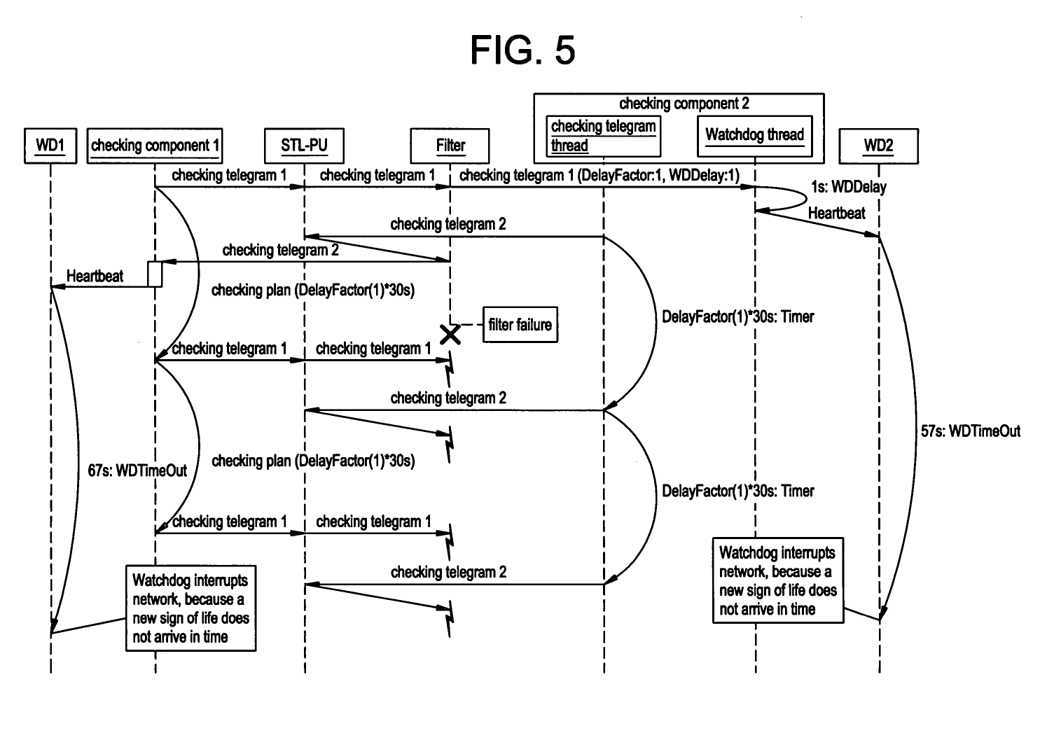

The scenario in the event of filter failure is represented in FIG. 5 in the form of a flow chart.

1^{st} Case: The telegram filter TF is regarded as having failed if the checking telegrams no longer pass through the filter. The checking components P1, P2 then no longer receive checking telegrams—i.e. no more signs of life are sent to the watchdog circuits WD1, WD2. The watchdog circuits WD1, WD2 then interrupt the network connection CTN permanently. Consequently, the secure failure state has been established.

2^{nd} Case: The telegram filter TF is regarded as having failed if all telegrams pass through the filter. According to the checking plan, a poisoning telegram is despatched that has been purposefully corrupted in one byte. Said poisoning telegram is still a checking telegram, but it does not comply with the checking-telegram rule of the telegram filter TF; it would be rejected in the case of a functioning telegram filter. Furthermore this case will additionally be revealed during the throughput-restriction check, since a poisoning telegram is also received in the event of a non-functioning throughput restriction. Consequently, no more checking telegrams are despatched. The watchdog circuits then interrupt the network connection CTN permanently, and the secure failure state has been established.

In addition, the firewall STL-PU also assumes the secure failure state, since no checking telegrams are transmitted any longer through it.

A quantitative restriction is also configured in the filter rule for checking telegrams. The checking components send a burst of checking telegrams at regular intervals. The last telegram of such a burst is always a special poisoning telegram. If the throughput restriction is functioning, such a poisoning telegram can never reach a checking component P1, P2, since it is already rejected in the telegram filter TF. In the event of failure of the throughput restriction, the checking component P1, P2 receives this poisoning telegram; the checking component P1, P2 then no longer sends signs of life to the watchdog circuit. Hence the secure failure state is attained.

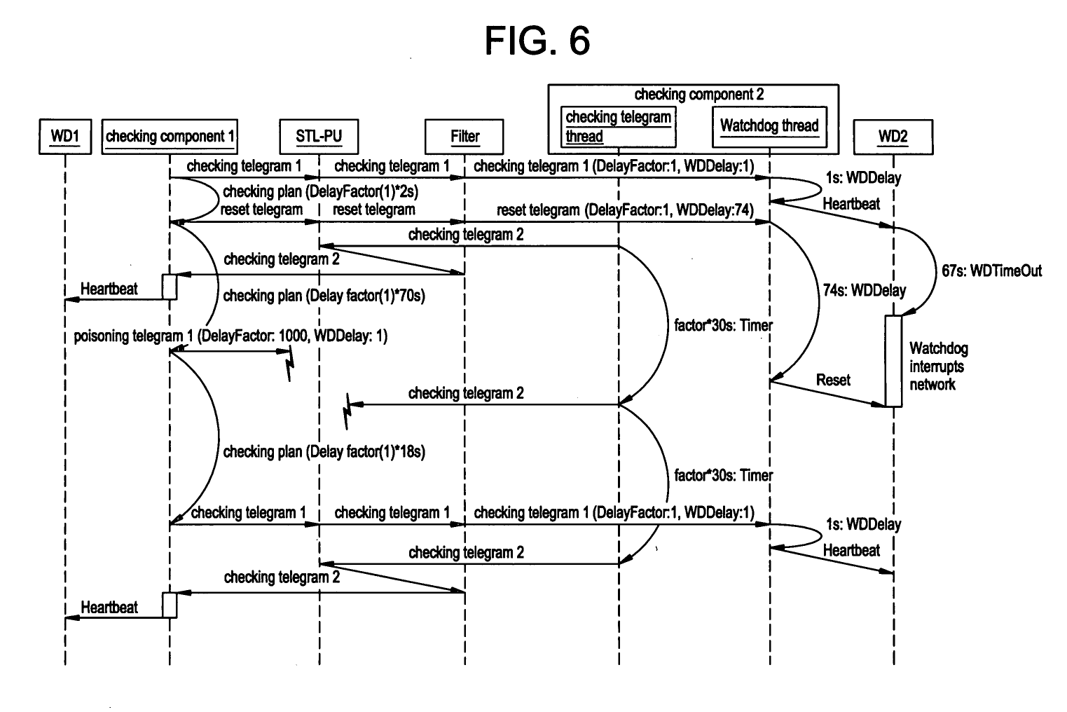

In FIG. 6 the examination of the watchdog circuits WD1, WD2 is represented in the form of a flow chart. In this case, a check is made at regular intervals as to whether each watchdog circuit WD1, WD2 is able to establish the secure failure state. The checking plan of the checking components contains a segment for the watchdog checking. On the basis of the checking plan, checking component P1 sends a special watchdog-reset telegram. In this checking telegram the watchdog delay is greater than the watchdog timeout of the watchdog circuit. On the basis of the receipt of this watchdog-reset telegram, checking component P2 generates a reset command to watchdog circuit WD2 after expiration of the watchdog delay contained in the telegram. On the basis of its checking plan, checking component P1 firstly sends no further checking telegrams. Watchdog circuit WD2 consequently obtains no sign of life within its watchdog timeout and interrupts the network until such time as it receives a reset. Directly after the watchdog-reset telegram, checking component P1 sends a poisoning telegram to checking component P2. This telegram, however, does not reach checking component P2, since watchdog circuit WD2 has interrupted the network. Checking component P1 thereupon again sends ‘normal’ checking telegrams to checking component P2, which trigger the signs of life to watchdog circuit WD2 which has meanwhile re-established the network connection by means of the reset.

The same scenario is also run through in time-shifted manner (according to the checking plan) by checking component P2, and consequently watchdog circuit WD1 is examined.

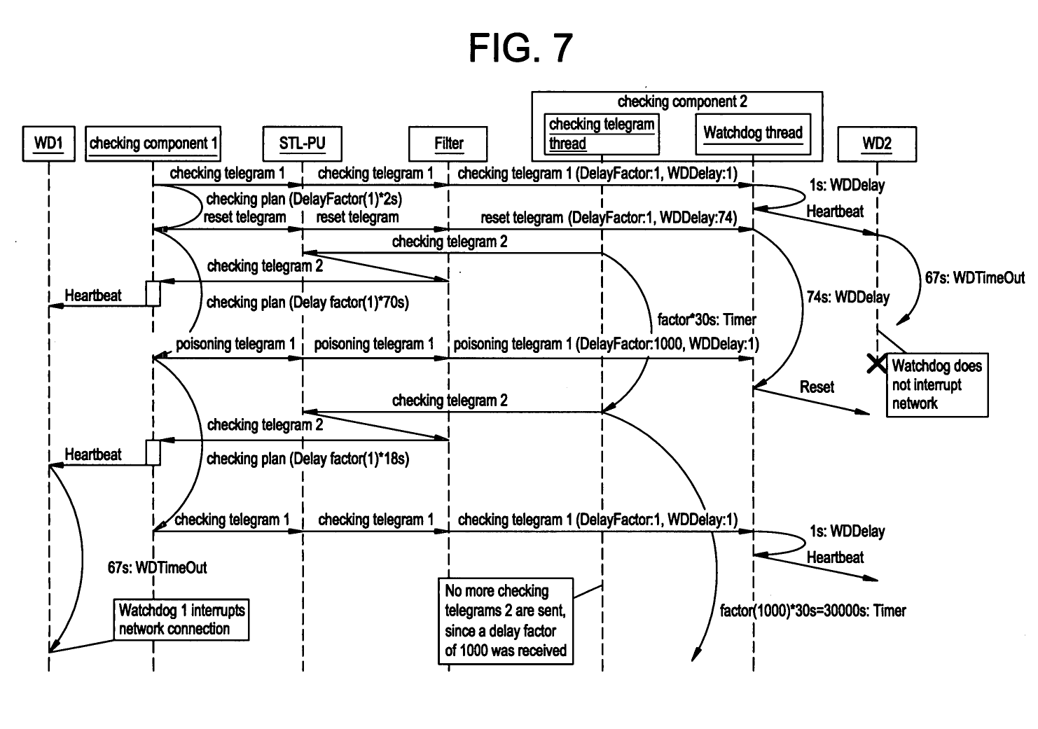

The scenario in which a watchdog circuit fails is shown in FIG. 7 in a flow chart. In the event of a failed watchdog circuit WD2, the network is not interrupted—i.e. checking component P2 receives the poisoning telegram. In checking component P1 this results in the suspending of the signs of life being sent to watchdog circuit WD2 which then interrupts the network. Consequently, even in the event of failure of a watchdog circuit WD1 the secure failure state is attained by means of the second watchdog circuit WD1. The same scenario applies to “watchdog circuit WD1 failed”.

The two checking components examine each other. Checking component P1 sends checking telegrams to checking component P2; checking component P2 sends checking telegrams to checking component P1. In the event of failure or a fault of a checking component, signs of life are no longer sent to the associated watchdog circuit. Hence the secure failure state is attained.

In addition, it is ensured that the data to be read in from the hard disc have not been corrupted at the start-up of the STL. For this purpose, after read-in the checksum is created via these data and is compared with the checksum which is likewise on the hard disc. In the event of a difference, the start-up of the security translator STL is terminated.

The static system data that have been read in have to be constantly checked against random corruptions in the memory. These data are held by various components (checking component P1, checking component P2, telegram filter TF) in different memory areas. For each checking telegram received, a filter component creates a checksum via a byte sequence consisting of:
filter rules in its own memory
checking plan in its own memory
sequence number (constituent of the received telegram).

This checksum is entered into the checking telegram by the filter component and is relayed to the telegram router TR. The receiving checking component likewise creates the checksum via filter rules and checking plan in its own memory, as well as received sequence number. The checking component compares the checksum+corruption byte from the received telegram with the specifically computed checksum+corruption byte=0 (hard-coded). If the checking component establishes a difference, the static system data of a component have been corrupted. The detecting checking component then rejects this checking telegram—i.e. no sign of life is sent to the watchdog. Several rejected checking telegrams result in the secure failure state.

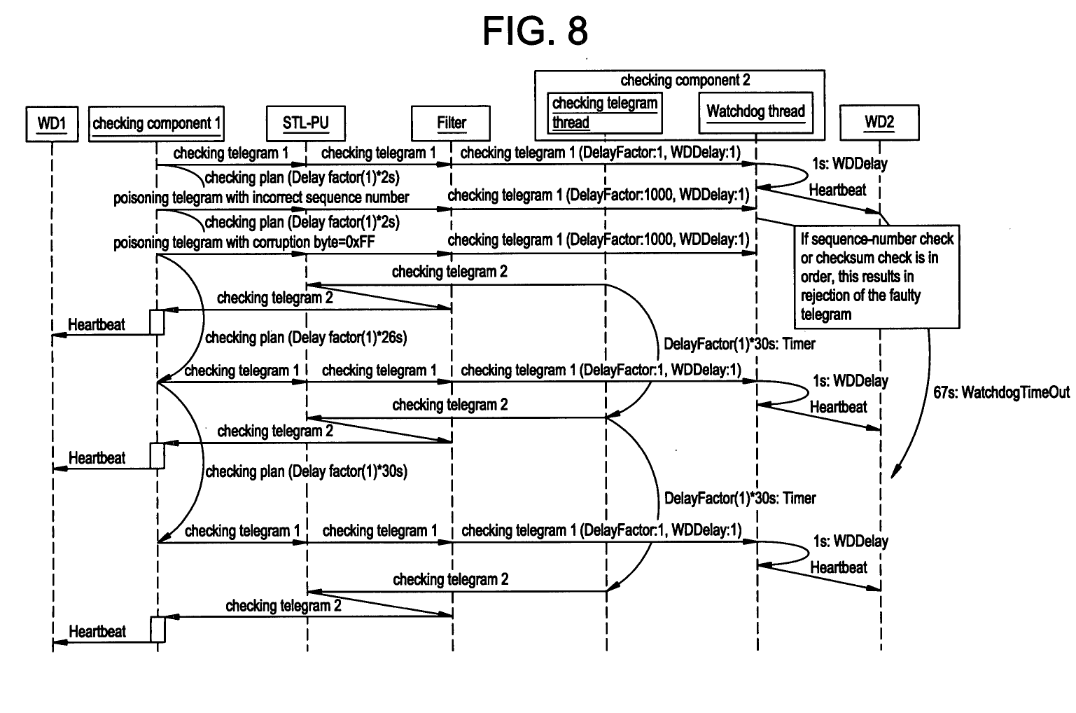

The sequence-number checking and the checksum check are shown In FIG. 8 in a flow chart. To this end, a check is made at regular intervals as to whether telegrams with an invalid checksum are being rejected. The checking plan of the checking components contains a segment for the checksum checking. On the basis of its checking plan, the checking component sends a poisoning telegram with corruption byte=0xFF. If the checking is functioning, this telegram is rejected and the system that is running remains unaffected. In addition, a check is made at regular intervals as to whether telegrams with invalid sequence numbers are being rejected. The checking plan of the checking components contains a segment for the sequence-number checking. On the basis of its checking plan, the checking component sends a poisoning telegram with an invalid sequence number. If the sequence-number checking is functioning, this telegram is rejected and the system that is running remains unaffected.

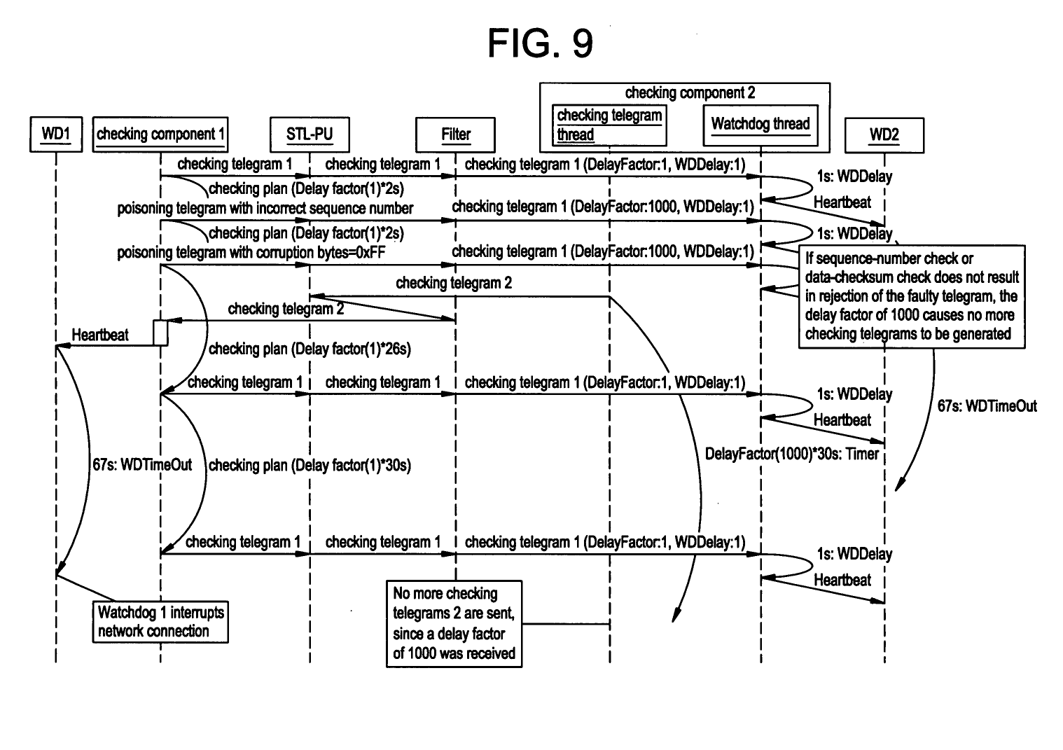

The failure of sequence-number checking or checksum check results in the scenario that is represented in FIG. 9 in the form of a flow chart. If the checksum checking or the sequence-number checking is no longer functioning, a poisoning telegram reaches a checking component. This results in the secure failure state.

The invention has been described with reference to the specific application of the security translator STL at the transition between IB3 and IB1. But it is, of course, equally suited for use for the IB2-IB1 transition. Whether the transition is made to IB2 or IB3 depends on the connection of the ZLV bus. For the sake of simplicity, only the transition to IB3 has been considered, since in the other case the requirements are more modest.

1. An apparatus for connecting a data network pertaining to a lower security level to a data network pertaining to a higher security level, including
a telegram filter for filtering telegrams out of the data network with a lower security level in accordance with predetermined filter rules,
a first checking component which is designed to generate checking telegrams and to send them via the telegram filter to a second checking component and
a watchdog circuit activated by the second checking component, which is designed to keep the connection between the data network with a lower security level and the data network with a higher security level closed as long as it receives regular signs of life from the second checking component and which is designed to interrupt the connection automatically if it receives no sign of life over a predetermined period,
the second checking component being designed to generate a sign of life for the watchdog circuit after receipt of a checking telegram that is permitted in accordance with the filter rules and to suppress a generation of signs of life for the watchdog circuit for at least the predetermined period after receipt of a checking telegram that is not permitted in accordance with the filter rules.

2. Apparatus according to claim 1, wherein the second checking component contains a time-interval factor which influences the time interval after which a sign of life for the watchdog circuit is generated, and wherein the checking telegrams contain a delay factor which is multiplied by a delay value of the timer, telegrams that are permitted in accordance with the filter rules containing the delay factor 1 and telegrams that are not permitted in accordance with the filter rules containing a higher delay factor.

3. Apparatus according to claim 1, including a second watchdog circuit which is activated by the first checking component and which is designed to keep the connection between the data network with a lower security level and the data network with a higher security level closed as long as it receives regular signs of life from the first checking component and which is designed to interrupt the connection automatically if it receives no sign of life over a predetermined period, the second checking component being designed to generate checking telegrams and to send them via the telegram filter to the first checking component, and the first checking component being designed to generate a sign of life for the second watchdog circuit after receipt of a checking telegram that is permitted in accordance with the filter rules and to suppress a generation of signs of life for the second watchdog circuit for at least the predetermined period after receipt of a checking telegram that is not permitted in accordance with the filter rules.

4. Apparatus according to claim 3, wherein each of the two checking components contains a time-interval factor which influences the time interval in which the next checking telegram is sent to the other checking component, and wherein the checking telegrams contain a delay factor which is multiplied by the time-interval factor and stored as a new time-interval factor, telegrams that are permitted in accordance with the filter rules containing the delay factor 1 and telegrams that are not permitted in accordance with the filter rules containing a higher delay factor.

5. Apparatus according to claim 3, wherein the first and the second watchdog circuits are connected in series.

6. Apparatus according to claim 1, including a firewall with a TCP proxy, arranged between the data network with a lower security level and the telegram filter, checking telegrams being routed from the checking components via the firewall to the telegram filter, and the watchdog circuits being designed to interrupt the connection between the firewall and the telegram filter.

7. Apparatus according to claim 1, wherein the telegram filter and the two checking components take the form of program modules which run on a computer, and the watchdog circuit is constructed as a plug-in card which is plugged into a computer.

8. A process for checking the integrity of an apparatus that serves for connecting a data network pertaining to a lower security level to a data network pertaining to a higher security level and that contains a telegram filter for the purpose of filtering telegrams out of the data network with a lower security level in accordance with predetermined filter rules and contains a watchdog circuit which is designed to keep the connection between the data network with a lower security level and the data network with a higher security level closed as long as it receives regular signs of life and which is designed to interrupt the connection automatically if it receives no sign of life over a predetermined period, the following steps being executed in the course of the process:
checking telegrams are generated and are sent to a checking component via the telegram filter,
after receipt of a checking telegram that is permitted in accordance with the filter rules the checking component generates a sign of life for a watchdog circuit and
after receipt of a checking telegram that is not permitted in accordance with the filter rules the checking component suppresses a generation of signs of life for the watchdog circuit for at least a predetermined period.
